(19) United States
(12) Patent Application Publication
(10) Pub. No.: US 2009/0221324 A1
(43) Pub. Date: Sep. 3, 2009

(54) Switching Between the Wireless Communication System Mode and the Satellite Positioning System Mode, Based on the Detected Voice Activity of the Transmitter

(76) Inventors: Samuli Pietila, Tampere (FI); Ville A. Eerola, Hameenlinna (FI); Harri Matti Johannes Valio, Kammenniemi (FI)

Correspondence Address: HARRINGTON & SMITH, PC, 4 RESEARCH DRIVE, Suite 202, SHELTON, CT, 06484-6212, US

(21) Appl. No.: 12/085,091

(22) PCT Filed: Dec. 8, 2006
(86) PCT No.: PCT/IB2006/004035

§ 371 Date: Mar. 23, 2009

(30) Foreign Application Priority Data
Dec. 9, 2005 (GB) 0525096.4

(51) Int. Cl. H04M 1/00; H04B 1/69

(52) U.S. Cl. 455/552.1; 375/147

(57) ABSTRACT

A method for a first wireless communication device to operate in wireless communication system mode and satellite positioning system mode. The first wireless communication device communicates with a second communication device. Voice activity of at least one of the communication devices is determined and based on the determined voice activity, the first wireless communication device switches between wireless communication system mode and satellite positioning system mode. The voice activity can be determined by using voice activity detector in at least one of the communication devices.

### FIELD OF THE INVENTION

Embodiments of the invention relate to a combined global navigation satellite system (GNSS) receiver and cellular system receiver. More specifically embodiments of the invention relate to a receiver in which the radio path between GNSS and cellular system signals can be shared. Embodiments of the invention also relate to a corresponding method, system, module and computer program product.

### BACKGROUND OF THE INVENTION

In cellular systems, different multiple access techniques can be applied depending on the cellular system standard. In the global system for mobile communications (GSM), combined time and frequency division multiple access techniques are applied (TDMA/FDMA). The FDMA technique involves the division of the 25 MHz bandwidth into 124 carrier frequencies spaced 200 kHz apart. Several carrier frequencies can be assigned to each base station (BS). According to the TDMA technique, these carrier frequencies are then divided in the time domain. The fundamental time unit in this TDMA technique is called a burst period (or time slot) and it lasts 15/26 ms (or approximately 0.577 ms). Eight burst periods or time slots are grouped into a TDMA frame ( 120/26 ms, or approximately 4.615 ms), which forms the basic unit for the definition of logical channels. One physical channel is defined to be one burst period per TDMA frame.

Minimising interference in the network is a goal in any cellular system, since it allows better service for a given cell size, or the use of smaller cells, thus increasing the overall capacity of the system. Discontinuous transmission (DTX) aims at increasing the system efficiency through a decrease of the interference level by inhibiting the transmission of the radio signal when not required from an information point of view. DTX takes advantage of the fact that a person speaks less than 40 percent of the time in normal conversation. An added benefit of DTX is that power is conserved at the mobile unit. DTX is also called variable bit rate since in the DTX mode the transmitted bit rate is less than in a situation in which a person is speaking.

The most important component of DTX is voice activity detector (VAD). It must distinguish between noise and voice inputs. When the transmitter is turned off, there is total silence heard at the receiver. To assure the receiving end that the connection is not dead, comfort noise is created at the receiver to match the transmitting end's background noise characteristics. For instance in GSM, the noise characteristics are transported to the receiving end by specific frames called silence descriptor (SID) frames. A SID frame is sent at the beginning of every inactivity period, and more are then sent regularly, at least twice a second, as long as the inactivity lasts. Therefore, the receiving end can generate comfort noise based on the received SID frame. DTX can be used also in systems employing code division multiple access (CDMA) technique. An example of such a cellular system is for instance universal mobile telecommunication system (UMTS), which employs wideband CDMA.

Currently GNSS receivers are being integrated into cellular system terminals. FIG. 1 presents a prior art solution in which two separate radio frequency (RF) sections are used; one for cellular signals and one for satellite signals. It is also possible to use a common shared RF section for both GNSS and cellular system receivers. FIG. 2 presents this solution in which a common RF section is shared between GNSS and cellular system reception. If there is a need for GNSS and cellular system receivers to operate simultaneously, the RF section must be time shared between these two receivers. This degrades the performance of both receivers.

U.S. Pat. No. 6,831,911 by Ashvattha Semiconductor Inc relates generally to a system and method for receiving and processing global positioning system (GPS) and wireless phone signals using a combination receiver, more particularly, receiving and processing GPS signals and wireless signals during alternate time segments by suspending reception of GPS signals during times when wireless signal is received. In the event that the user desires to place or receive a wireless phone call, using a time division technology wireless phone, the receiver will suspend reception of GPS signal to receive or transmit the wireless phone signal. Therefore, it becomes possible to combine a GPS receiver and a wireless phone using a single integrated circuit because either the GPS receiver or the wireless phone is operating, but not both at the same time. A TDMA wireless phone signal can be received and processed in time segments alternating with a GPS signal. The TDMA data is sent in signal bursts that last a predetermined length of time in accordance with the particular time division standard. Therefore, the GPS receiver can be turned on to receive a GPS signal, then turned off to receive a TDMA signal. When the TDMA signal has been received, the receiver can be switched to the GPS operational mode again.

### SUMMARY OF THE INVENTION

The applicant has recognised that there is a need to share the RF section part of the receiver between the cellular and GNSS signals based on the detected voice activity of the transmitter.

According to a first aspect of the invention, there is provided a method for a first wireless communication device to operate in wireless communication system mode and satellite positioning system mode, wherein in the satellite positioning system mode the first wireless communication device receives signals from the satellite positioning system and in the communication system mode it receives signals from the communication system, the method comprising the first wireless communication device: communicating with a second communication device; determining voice activity of at least one of the communication devices; based on the determined voice activity, switching between the wireless communication system mode and the satellite positioning system mode.

The invention has in accordance with one embodiment the advantage that it provides a way to optimise the performance of the communication device with minimal speech quality degradation. The invention makes it possible to switch between satellite system signal reception and communication system signal reception.

Further, according to a first aspect of the invention the wireless communication device is a mobile phone handset.

Other aspects of the invention are in the claims appended hereto.

### BRIEF DESCRIPTION OF THE FIGURES

These and other features of the present invention will by way of example become apparent from the following detailed description when considered in conjunction with the accompanying drawings, in which:

FIG. 1 illustrates a block diagram of a prior art solution for receiving cellular and satellite positioning system signals;

FIG. 2 illustrates a block diagram of another prior art solution for receiving cellular and satellite positioning system signals;

FIG. 3 illustrates an environment in which embodiments of the invention can be applied;

FIG. 4 is a block diagram illustrating a wireless terminal in accordance with an embodiment of the invention;

FIG. 5 is a simplified flow diagram in accordance with an embodiment of the invention;

FIG. 6 is a block diagram of the signal reception and RF parts of the receiver in accordance with an embodiment of the invention;

FIG. 7 is a flow diagram in accordance with an embodiment of the invention;

FIG. 8 illustrates one operation mode of the receiver as a function of time in accordance with an embodiment of the invention;

FIG. 9 illustrates another operation mode of the receiver as a function of time in accordance with an embodiment of the invention;

FIG. 10 is a flow diagram in accordance with another embodiment of the invention;

FIG. 11 illustrates another operation mode of the receiver as a function of time in accordance with an embodiment of the invention;

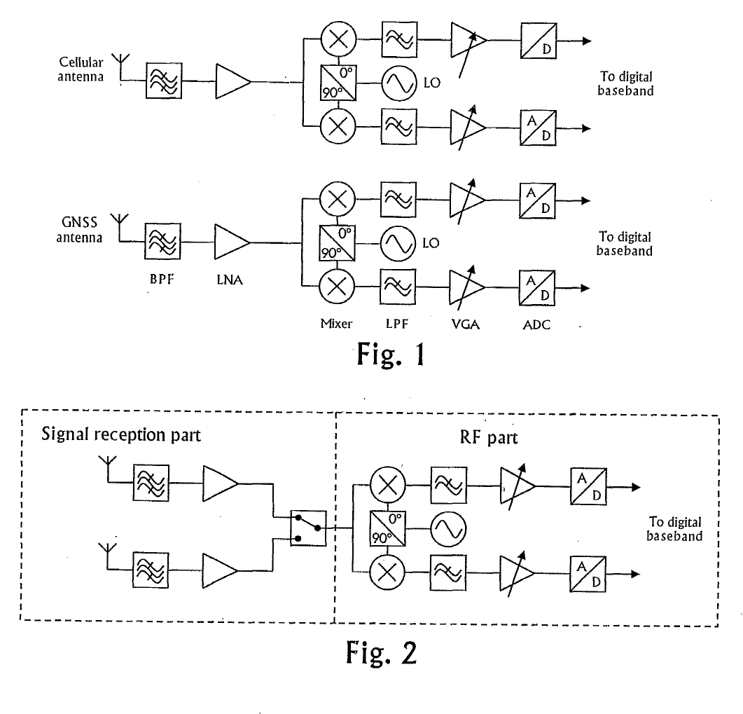

### DETAILED DESCRIPTION OF EMBODIMENTS OF THE INVENTION

### Operational Environment

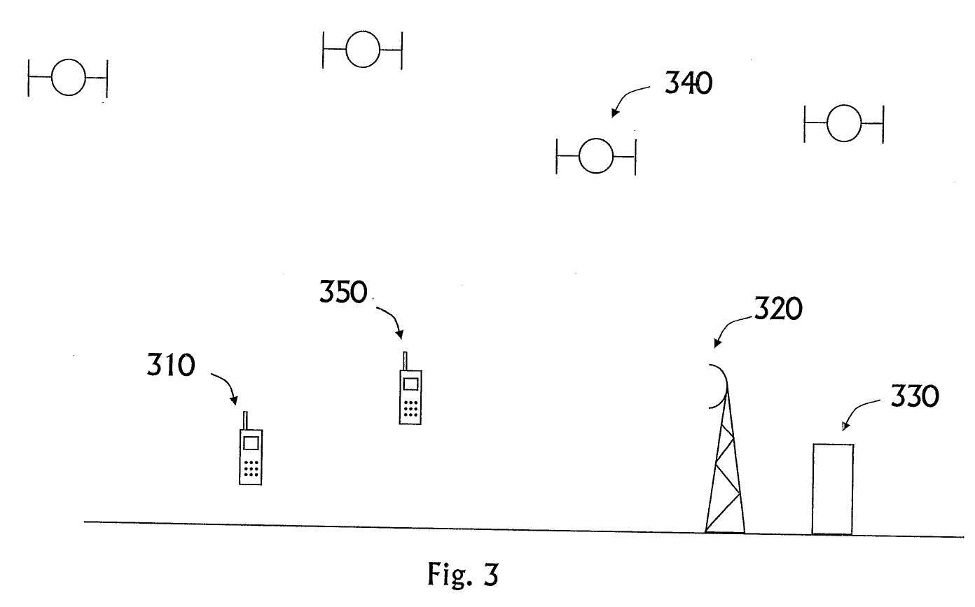

FIG. 3 illustrates an operational environment in which embodiments of the present invention may exist. Specifically, in FIG. 3, there are shown portable electronic devices 310, 350, in this case mobile phone handsets.

FIG. 3 also shows two communication network elements. First network element is an access point 320, in this case a base station (BS). The first network element could also be any other access point capable of communicating with the communication device 310. The base station 320 can work according to any existing standard, for instance GSM, GPRS, EDGE, HSCSD, UMTS, CDMA 2000, IS95, etc., or future cellular network standards. Alternatively, base station 320 could act as an access point of a wireless local area network, such as Bluetooth, WiMAX, or any variation of 802.11 standard. Furthermore, base station 320 could be connected to the mobile phone handset with any other suitable wireless connectivity method. The second network element is a mobile switching centre (MSC) 330. MSC 330 controls the operation of a cellular network. Furthermore, the environment of FIG. 3 includes four GNSS satellites 340. The communication network may also comprise other network elements not shown in the figure, for instance a base station controller (BSC).

The mobile phone handsets 310, 350 communicate with each other via the communication network comprising the BS 320 and the MSC 330. The BS 320 communicates with the mobile phone handsets 310, 350 using RF transmissions or any other suitable communication means in order to transmit signals to the mobile phone handsets 310, 350. Accordingly, the mobile phone handsets 310, 350 receive transmissions sent by the BS 320. The mobile phone handsets 310, 350 also send signals to the BS 320. Thus, the communication is two directional. BSs and MSCs form part of the cellular communications network, such as a GSM network. In this particular exemplary embodiment the mobile phone handsets 310, 350 are communicating with each other and the handset 310 is also able to receive signals from at least one of the satellites 340. The satellites 340 transmit signals to the mobile phone handsets 310, 350 either directly, without intervention of the communication network or via the cellular communication network so that the communication network can send assistance data to the mobile phone handsets 310, 350. Wireless communication link is used for signal transmissions from the satellites 340 to the handsets 310, 350 and to the BS 320. In the communication network, the satellite signals are received by a location measurement unit (LMU), which may be physically located in the same place as the BS 320. If however, the LMU is located in the different place than the BS 320, the signal needs to be conveyed to the BS 320 so that the BS 320 can then send it to the mobile phone handsets 310, 350. The signals received from the satellites 340 can also be processed before they are sent to the mobile phone handsets 310, 350 as assistance data.

### Handset

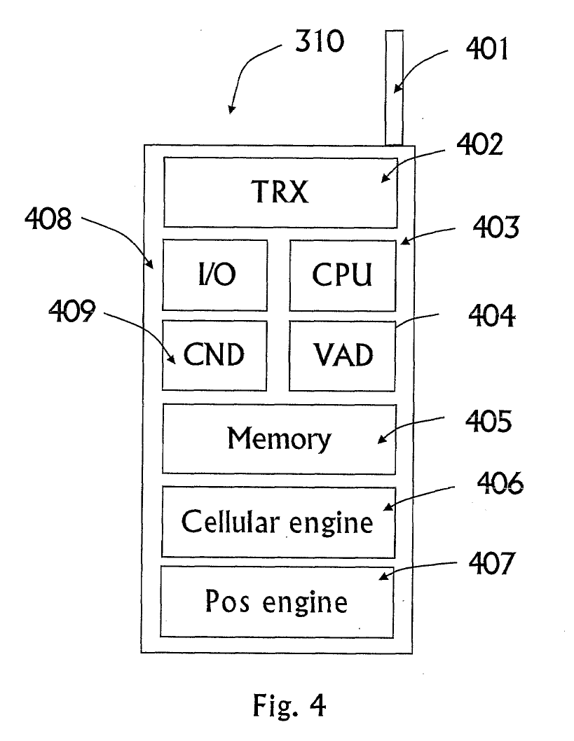

FIG. 4 is a block diagram of the mobile phone handset 310 or 350 of FIG. 3. The handset 310 functions as a cellular telephone according to, for instance, one or many of the following standards: GSM, GPRS, EDGE, HSCSD, UMTS, CDMA 2000, IS95, etc. The handset 310 comprises a memory 405. The memory may have random access (RAM) and read only memory (ROM) parts. Suitable data can be stored in that memory. Furthermore, handset 310 contains input/output (I/O) means 408. Input means may be, for instance, a keyboard but it can also be a touch pad or a touch screen. A microphone may also be provided as an input means for receiving voice information. Output means may be provided for instance by a display, such as a liquid crystal display (LCD). A loudspeaker may also be provided as an output means for outputting speech or sound. Other suitable input/output means are also possible.

The handset 310 also includes a cellular engine 406 for providing communication capabilities with the cellular communication network, such as GSM network. For receiving and processing the satellite transmissions, the handset comprises a positioning engine (pos engine) 407. The handset 310 also includes transceiver unit 402 (TRX). For receiving and transmitting signals, the handset 310 includes an antenna 401. Two or more physically separated antennas could also be used, but in this embodiment the cellular and satellite system antennas are combined into a single physical antenna which can receive and transmit signals of the cellular system and receive signals of the satellite system.

The handset 310 also includes a central processing unit 403 (CPU) for centrally controlling the functioning of the handset 310. The CPU includes one or more processing units depending on the implementation of the handset 310. For detecting voice activity, the handset 310 comprises a VAD 404 and for detecting the comfort noise received by the antenna 401, the handset 310 comprises a comfort noise detector (CND) 409.

### General Methodology

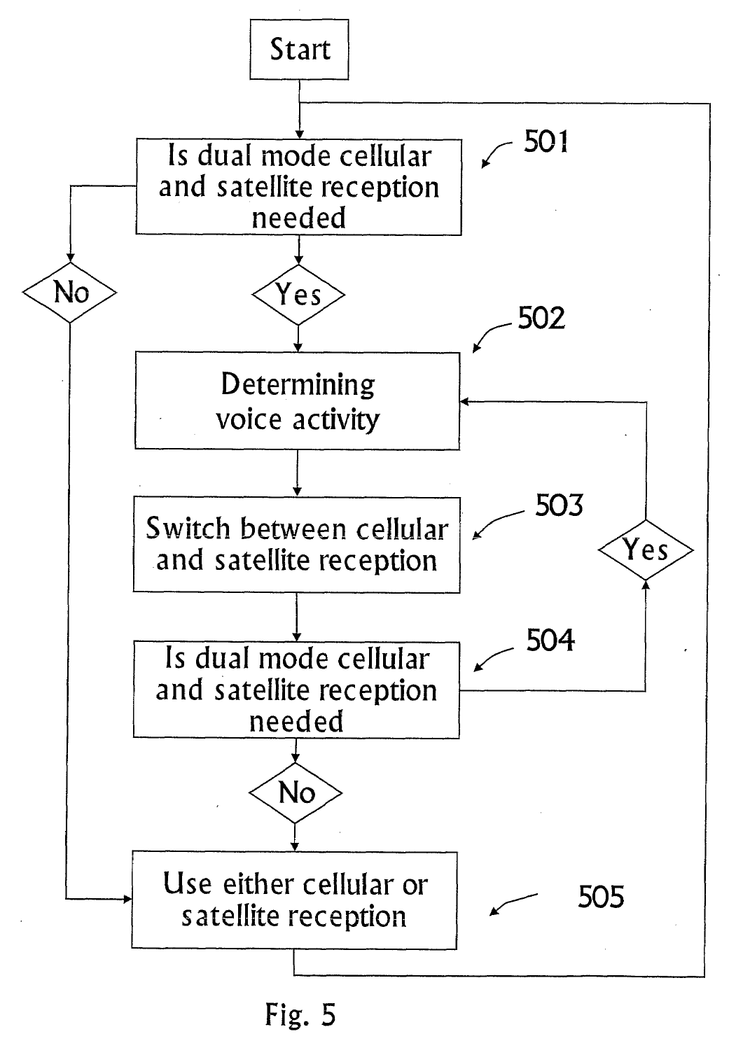

FIG. 5 illustrates a simplified flow chart for depicting a method for the handset 310 to receive signals both from the handset 350 and from any of the satellites 340 in accordance with one embodiment of the invention. For the sake of clarity, in this exemplary embodiment the handset 310 is denoted as a receiving handset 310 and the handset 350 is denoted as a transmitting handset 350 even though both of the handsets 310 and 350 are capable of receiving and transmitting signals. At step 501 it is determined whether dual mode reception of both cellular system and satellite positioning system signals is needed. By dual mode reception it is meant a situation in which the receiver is able to receive signals from the cellular network and from the satellites using an appropriate multiplexing method, such as time division multiplexing.

If there is no need for dual mode signal reception, then at step 505 either one of these signals can be received at a time or there may not be a need for any signal reception. If however at step 501 it is determined that there is a need for dual mode signal reception, then at step 502, voice activity of the transmitting handset 350 is determined. At step 503 signal reception is switched between cellular and satellite system reception depending on the transmitting handset 350 voice activity determined in step 502. If the transmitting handset 350 is silent, then the RF section of the receiving handset 310 can be predominantly used for reception of satellite signals. If it is determined that the transmitting handset 350 is not silent, then the RF section of the receiver can be predominantly used for reception of cellular system signals. At step 504 it is again determined whether there is a need for dual mode reception of signals from the satellites 340 and from the cellular system. If there is a need for dual mode signal reception then the voice activity is again determined at step 502. If there is no need for dual mode signal reception then at step 505 either satellite or cellular system signals can be received at a time or there may not be a need for any signal reception.

### Receiver Architecture

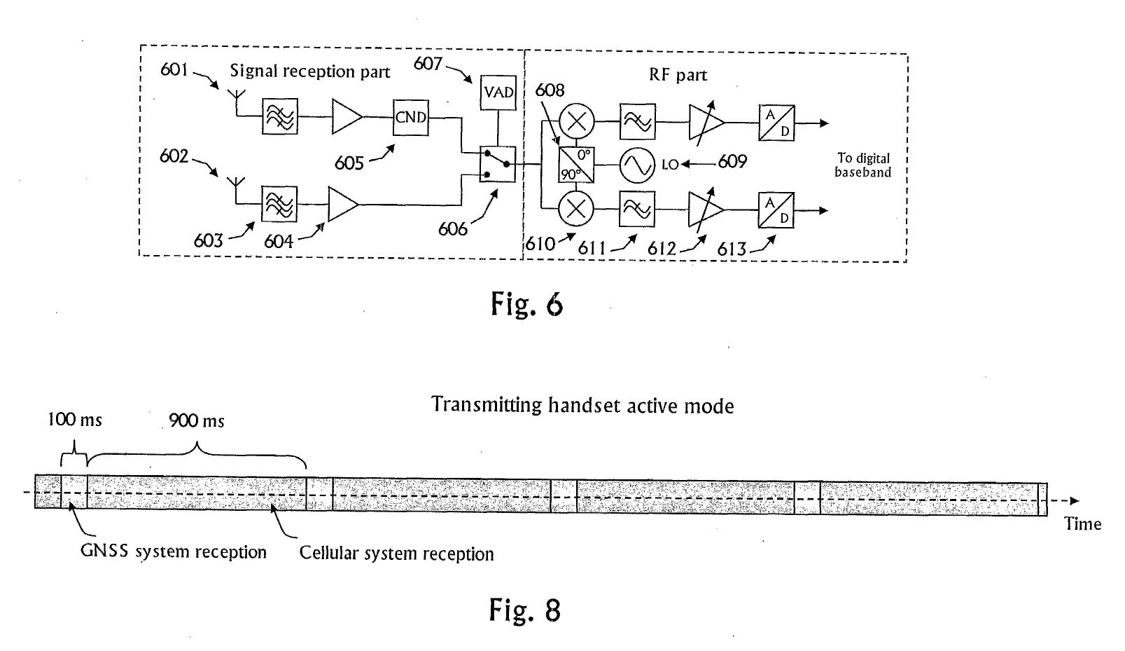

FIG. 6 describes a signal reception and RF part for receiving signals from cellular and satellite positioning systems in accordance with an embodiment of the invention. The signal reception part consists of two branches; one branch for cellular system signal reception and one branch for satellite system signal reception. Each branch comprises an antenna 601, 602 for receiving RF signals and a band pass filter (BPF) 603 for filtering out low and high frequencies. Each branch further comprises a low noise amplifier (LNA) 604 for amplifying the signal after the BPF. The cellular system reception part also comprises a comfort noise detector (CND) 605 for detecting the SID frames received by the antenna 601. The CND 605 can also detect comfort noise generated by the handset 310. After the signal reception part there is a selector or switch 606 for selecting signals either from the cellular system signal reception branch or from the satellite system signal reception branch. Functionally connected to the switch 606, there is also a voice activity detector 607. In accordance with this invention, the switch 606 is programmed to switch between the satellite system and cellular system reception parts depending on the information received from the CND 605 and/or VAD 607. The CND 605 block does not necessary have to be physically located between the LNA 604 and the switch 606.

After the selector 606 the signal is led into the RF section part where the signal is divided into two different branches. These two branches comprise same components and the difference in these two branches is that the signal has in the other branch 90 degrees phase offset due to the phase offset block 608. After the selector 606 the signal is mixed with the local oscillator 609 signal and for the signal in the other branch a 90 degrees phase offset is introduced. After the mixer 610, there is a low pass filter (LPF) 611 for filtering out high frequencies. After the LPF 611, the signal is amplified by variable gain amplifier (VGA) 612 and finally the analogue signal is converted to digital form by the analogue-to-digital (A/D) converter 613. The signal is then led to digital base band part of the receiver.

### Detailed Methodology

The operation of the handset 310 of FIGS. 3 and 4 will now be described in more detail with reference to FIG. 4 and the flow charts of FIGS. 5, 7 and 10. In FIG. 5, at step 501, the receiving handset 310 determines whether dual mode signal reception is needed from the transmitting handset 350 in the cellular system and from the satellite positioning system satellites 340. In these exemplary embodiments, the communication system is a cellular system, especially a system working in accordance with the GSM standard, but the communication system could also be other than a cellular system. The satellites 340 may operate according to the following standards: Global Positioning System (GPS), Russian GLONASS or European alternative Galileo, which is not yet in operation, or some other satellite navigation system. If there is no need for dual mode signal reception, then at step 505, only one signal either from the cellular system or satellite system is received at a time. It is possible also not to receive any signal, for instance when the receiver is switched off. Alternatively merely control channel signals can be received.

However, if it is determined at step 501 that there is a need for dual mode signal reception from both the transmitting handset 350 and from the satellites 340, then at step 502 voice activity of the transmitting handset 350 is determined. This can be done by the receiving handset 310 detecting data frames sent by the transmitting handset 350. If it is detected that the transmitting handset 350 has sent a specific frame, for instance a SID frame, indicating that the transmitting handset 350 is inactive, then the receiving handset 310 can determine that the transmitting handset 350 is not speaking, i.e. it is inactive. The transmitting handset 350 can also send comfort noise to the receiving handset 310. In this case, if the VAD 404 of the handset 350 detects that the user of the handset 350 is not active, the comfort noise is sent at a lower bit rate than speech would be sent. This reduces load in the communication network. There can also be a VAD in the receiving handset 310 and when it is detected that the receiving handset 310 is silent then it can be predicted that the transmitting handset 350 is speaking. Or alternatively when it is detected that the receiving handset 310 is speaking then it can be predicted that the transmitting handset 350 is silent.

Then at step, 503 the selector 606 of FIG. 6 is programmed to switch between reception from the transmitting handset 350 and from the satellites 340 depending on the determined voice activity at the transmitting handset 350. If it is determined, by for instance receiving a SID frame, that the transmitting handset 350 is silent, then the selector 606 can switch to reception from the satellites 340 since there is no significant information sent by the transmitting handset 350. Then after certain time period the selector 606 can be programmed to switch back to cellular system reception in order to detect whether the transmitting handset 350 is still inactive. If it is detected that the user of the transmitting handset 350 has started to speak then the receiving handset 310 stays in the cellular system reception mode as far as the user of the transmitting handset 350 is again inactive. However, even if the user of the transmitting handset 350 is active, the selector can be programmed to switch for a short time period for satellite system mode. When the receiving handset 310 is operating in satellite system mode, there may be a need to receive for instance control channel signals from the cellular system at certain intervals even if the transmitting handset 350 is silent. So even if the user of the transmitting handset 350 is silent, there may be a need to receive signals from the cellular system at certain bit rate, which is lower than the bit rate used when the user of the transmitting handset 350 is speaking.

At step 504 it is again checked whether dual mode signal reception from the transmitting handset 350 and from the satellites 340 is still needed. If this is the case then again at step 502 the voice activity of the transmitting handset 350 is determined. If however there is no need for dual mode signal reception, then at step 505 just signals from the satellites 340 or from the transmitting handset 350 can be received at a time.

### Example 1

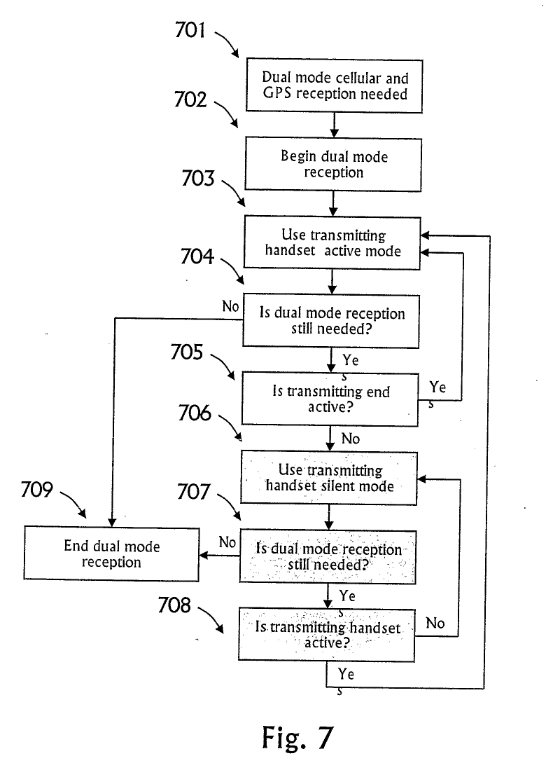

FIG. 7 shows a more detailed flowchart of the method in accordance with an embodiment of the invention. In this embodiment the VAD 404 is only needed in the transmitting handset 350. At step 701 it is determined that dual mode reception is needed from the satellites 340 and from the transmitting handset 350. At step 702 dual mode reception is started.

At step 703 the receiving handset 310 functions in transmitting handset active mode. In transmitting handset active mode the GNSS reception part is active, for instance, 100 ms in a second. In this case cellular system signal reception would be active a majority of the time, for instance 900 ms in a second. This is illustrated in FIG. 8. When the receiving handset 310 determines that the transmitting end 350 is active the handset can operate in cellular system mode. The handset can remain in this mode 900 ms at a time according to this exemplary embodiment. During this period, no signals from the satellite system are received.

Then at step 704 the receiving handset 310 determines whether dual mode reception is needed. If there is no need for dual mode reception, then at step 709 the dual mode reception can be terminated. If however dual mode reception is needed, then at step 705 it is determined whether the transmitting handset 350 is active or not. This can be done by the receiving handset 310 decoding data frames sent by the transmitting handset 350 during cellular system mode. If a SID frame is detected then the receiving handset 310 can determine that the user of the transmitting handset 350 is inactive. If however speech frames are received by the receiving handset 310, then it can be determined that the user of the transmitting handset 350 is speaking and is therefore active. The VAD 404 is needed in the transmitting handset 350 to detect whether the user of the transmitting handset 350 is active or not. If the user is not active, then data can be sent to the receiving handset 310 at a lower bit rate then speech would be sent. If the user of the transmitting handset 350 is active, then at step 703 transmitting handset active mode is used.

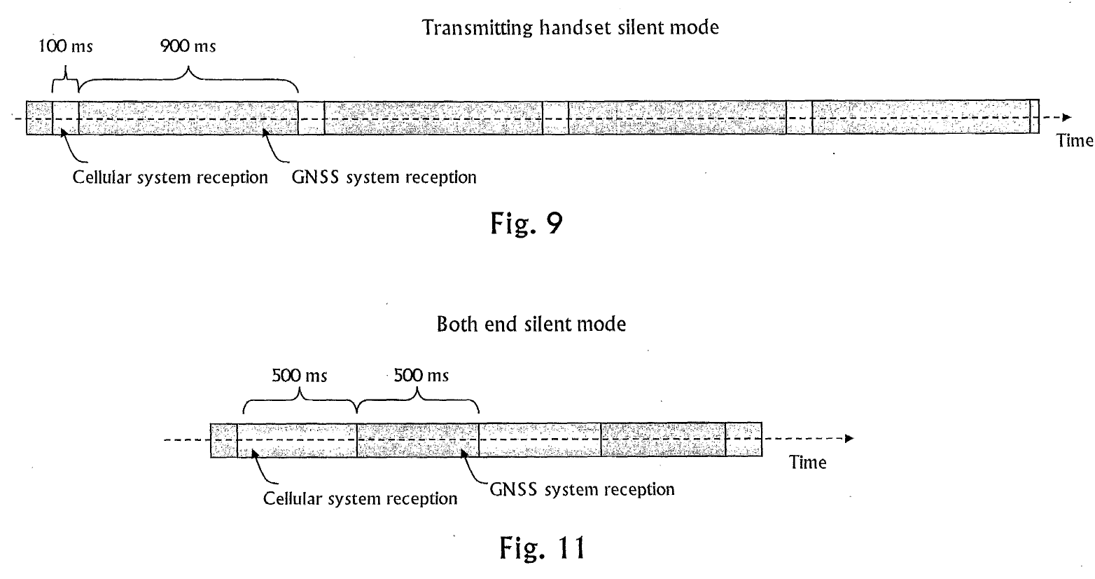

If the receiving handset 310 determines that the transmitting handset 350 is not active then at step 706 transmitting handset silent mode is used. In transmitting handset silent mode the GNSS reception part is active, for instance, 900 ms in a second. In this case cellular system signal reception would be active minority of the time, for instance 100 ms in a second. This is illustrated in FIG. 9. Some bursts sent by the transmitting handset 350 are missed to optimise the satellite system mode operation. The bursts that are missed may, for instance, contain SID frame information. The time period when the handset operates in satellite system mode cannot be too long so that if the transmitting handset 350 suddenly becomes active that does not degrade the received speech quality too much. Also other suitable active periods for the different reception parts can be used. Because the receiving handset 310 knows when it can expect to receive a SID frame, the moment when the handset is operating in the cellular system mode should preferably coincide with the reception of a SID frame. If during the cellular reception mode the receiving handset 310 detects that the transmitting handset 350 has become active, the receiving handset 310 can stay in cellular reception mode.

At step 707 it is again determined whether there is a need for dual mode signal reception. If there is no need for dual mode reception, then at step 709 the dual mode reception can be terminated. If dual mode reception is still needed then the receiving handset 310 determines at step 708 whether the transmitting handset 350 is active or not. If the transmitting handset 350 is not active, then at step 706 transmitting handset silent mode is used. If however the transmitting handset 350 is active, then at step 703 transmitting handset active mode is used.

### Example 2

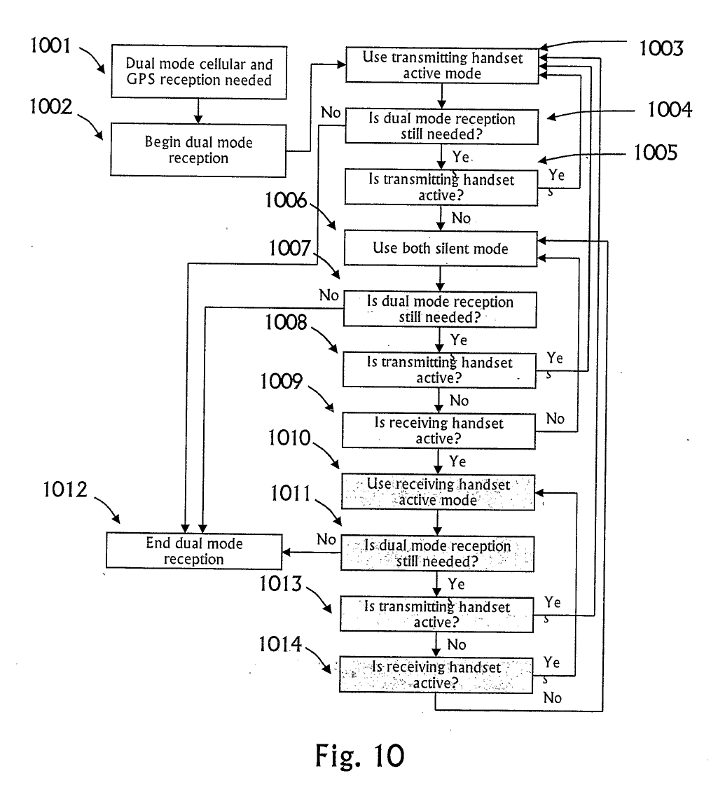

FIG. 10 presents another embodiment to implement the invention. In this embodiment VAD 404 is needed in both handsets 310 and 350. At step 1001 it is determined that dual mode reception is needed from the satellites 340 and from the transmitting handset 350. At step 1002 dual mode reception is started.

At step 1003 the receiving handset 310 functions in transmitting handset active mode. In transmitting handset active mode the GNSS reception part is active for instance 100 ms in a second. In this case cellular reception would be active majority of the time, for instance 900 ms in every second. Also other suitable active periods for the different reception parts can be used.

Then at step 1004 it is determined whether dual mode reception is needed. If there is no need for dual mode reception, then at step 1012 the dual mode reception can be terminated. If however the dual mode reception is needed, then at step 1005 the receiving handset 310 determines whether the transmitting handset 350 is active, i.e. the user of the transmitting handset 350 is speaking. If the transmitting handset 350 is active, then at step 1003 transmitting handset active mode is used. For detecting voice activity, the same methods can be employed as explained previously. Since in this embodiment, the VAD 404 is also in the receiving handset 310, it can be used for predicting voice activity of the user of the transmitting handset 350. If it is detected that the user of the receiving handset 310 is silent then it can be predicted that the user of the transmitting handset 350 is speaking. Or alternatively when it is detected that the user of the receiving handset 310 is speaking then it can be predicted that the user of the transmitting handset 350 is silent. If it is determined that the transmitting handset 350 is not active then at step 1006 the receiving handset 310 uses both end silent mode. In both end silent mode the cellular system reception part can be active for instance 500 ms in a second whereas the satellite reception part can be active equal time period. This is illustrated in FIG. 11. It is also possible that the other reception part is active longer than the other reception part. Finding the right values is a matter or trade-off between optimal satellite system mode operation and degradation of a received speech quality. Since both ends are silent, it is likely that other end will start speaking soon. Therefore time periods much longer than 500 may degrade the received speech quality too much when the receiver is in satellite system mode and the user of the transmitting handset 350 has just started to speak. In this respect shorter switching periods, such as 300 ms, may be preferred.

Then at step 1007 the receiving handset 310 determines whether dual mode reception is still needed. If there is no need for dual mode reception, then at step 1012 the dual mode reception can be terminated. If however the dual mode reception is needed, then at step 1008 it is determined whether the user of the transmitting handset 350 is active. If it is determined that the user of the transmitting handset 350 is active then at step 1003 transmitting handset active mode is used. If the user of the transmitting handset 350 is not active then at step 1009 the receiving handset 310 determines whether the user of the receiving handset 310 is active or not. This can be determined by using the VAD 404 in the receiving handset 310. If the user of the receiving handset 310 is active, then at step 1010 receiving handset active mode is used. In this mode the GNSS reception could be active for instance 900 ms in a second whereas the cellular reception part could be active the remaining time, i.e. 100 ms in a second. If at step 1009 the receiving handset 310 determines that the user of the receiving handset 310 is not active, then at step 1006 both end silent mode is used.

Then at step 1011 the receiving handset 310 again determines whether dual mode signal reception is needed. If there is no need for dual mode reception, then at step 1012 the dual mode reception can be terminated. If however the dual mode reception is needed, then at step 1013 the receiving handset 310 determines whether the user of the transmitting handset 350 is active. If the receiving handset 310 determines that the user of the transmitting handset 350 is active then at step 1003 transmitting handset active mode is used. If the user of the transmitting handset 350 is not active then at step 1014 the receiving handset 310 determines whether the user of the receiving handset 310 is active. If the receiving handset 310 determines that the user of the receiving handset 310 is active then at step 1010 the receiving handset active mode is used. If the user of the receiving handset 310 is not active, then at step 1006 both end silent mode is used.

The invention also relates to a corresponding computer program product, which can be used to implement at least some parts of the method according to the embodiments described above.

In the receiving handset 310 all inventive features could be incorporated into a single module. The module should at least include the selector switch and in some embodiments also the VAD 404 and/or CND 409.

The invention also relates to the receiving handset 310 and transmitting handset 350, which comprise means for implementing the methods described above. The receiving handset 310 and transmitting handset 350 may also comprise the module described above.

Furthermore the invention relates to a system in which the receiving handset 310 can be used. The system comprises at least the receiving handset 310 and transmitting handset 350 and at least one satellite 340.

It is to be noted that the described embodiments can be varied in many ways and that these are just exemplary embodiments of the invention.

1. A method for a first wireless communication device to operate in wireless communication system mode and satellite positioning system mode, wherein in the satellite positioning system mode said first wireless communication device receives signals from the satellite positioning system and in the communication system mode said first wireless communication device receives signals from the communication system, the method comprising said first wireless communication device: communicating with a second communication device; determining voice activity of at least one of the communication devices; based on the determined voice activity, switching between the wireless communication system mode and the satellite positioning system mode.

2. The method according to claim 1, wherein the method further comprises, when said second communication device is determined to have voice activity, said first communication device operates in wireless communication system mode.

3. The method according to claim 1, wherein the method further comprises, when said second communication device is determined to have no voice activity, said first communication device operates in satellite positioning system mode.

4. The method according to claim 1, wherein the method further comprises, when said first wireless communication device is determined to have voice activity, the first communication device operates in satellite positioning system mode.

5. The method according to claim 1, wherein the method further comprises, when said first wireless communication device is determined to have no voice activity, the first communication device operates in wireless communication system mode.

6. The method according to claim 1, wherein in the wireless communication system mode, signals from the wireless communication system are received at higher bit rate than signals from the satellite positioning system.

7. The method according to claim 1, wherein in the satellite positioning system mode, signals from the satellite positioning system are received at higher bit rate than signals from the wireless communication system.

8. The method according to claim 1, wherein the method further comprises, when said first and second communication devices are determined to have no voice activity, signals from the wireless communication system and from the satellite positioning system are received substantially at equal bit rates.

9. The method according to claim 1, wherein the voice activity is determined using voice activity detector in said first wireless communication device.

10. The method according to claim 1, wherein the voice activity is determined by said first wireless communication device by decoding data frames sent by said second communication device.

11. The method according to claim 1, wherein the voice activity is determined by said first wireless communication device by receiving silence descriptor frames.

12. The method according to claim 1, wherein said communication device is a mobile phone handset.

13. The method according to claim 1, wherein said communication system is a cellular communication system.

14. A first wireless communication device operable in wireless communication system mode and satellite system mode, wherein in the satellite positioning system mode said first wireless communication device receives signals from the satellite positioning system and in the communication system mode said first wireless communication device receives signals from the communication system, the first wireless communication device comprising: means for communicating with a second communication device; means for determining voice activity of at least one of the communication devices; means for switching between wireless communication system mode and satellite positioning system mode based on the determined voice activity.

15. The wireless communication device according to claim 13, wherein said communication device is a mobile phone handset.

16. A module in a first wireless communication device for switching between wireless communication system mode and satellite positioning system mode wireless, wherein in the satellite positioning system mode said first wireless communication device receives signals from the satellite positioning system and in the communication system mode said first wireless communication device receives signals from the communication system, the module comprising: means for communicating with a second communication device; means for determining voice activity of at least one of the communication devices; means for switching between wireless communication system mode and satellite positioning system mode based on the determined voice activity.

17. A system comprising a wireless communication device according to claim 14, at least one satellite and at least a second communication device.

18. A computer program product, comprising program code sections for carrying out the steps of claim 1.
